(19) United States
(12) Patent Application Publication
(10) Pub. No.: US 2024/0323089 A1
(43) Pub. Date: Sep. 26, 2024

(54) MANAGEMENT SYSTEM, MANAGEMENT DEVICE, AND MANAGEMENT METHOD

(71) Applicant: NEC Corporation, Minato-ku, Tokyo (JP)

(72) Inventor: Shohei BABA, Tokyo (JP)

(73) Assignee: NEC Corporation, Minato-ku, Tokyo (JP)

(21) Appl. No.: 18/580,200

(22) PCT Filed: Sep. 30, 2021
(86) PCT No.: PCT/JP2021/036232

§ 371 Date: Jan. 18, 2024

(51) Int. Cl. H04L 41/0895; H04L 41/0806

(52) U.S. Cl. CPC H04L 41/0895; H04L 41/0806

(57) ABSTRACT

A management system includes management means for managing a plurality of data centers included in a first area, management means for managing a plurality of data centers included in a second area, and management means for selecting a data center candidate in which a first virtual node is to be deployed and a data center candidate in which a second virtual node is to be deployed based on communication performance information between the data centers, in which the management means specifies a data center in which the first virtual node is to be deployed based on the candidate in which the first virtual node is to be deployed, and the management means specifies a data center in which the second virtual node is to be deployed based on the candidate in which the second virtual node is to be deployed.

### TECHNICAL FIELD

The present disclosure relates to a management system, a management device, and a management method.

### BACKGROUND ART

At present, virtualization of devices configuring a core network is being considered. In the future, in preparation for the spread of the 5th Generation (5G) network, it is expected that virtualization of RAN components in an Open Radio Access Network (O-RAN) Alliance will be promoted.

Patent Literature 1 discloses a configuration of a resource allocation system that maps a virtual network to a physical infrastructure to satisfy the reliability expected for a service and achieve optimal use of reliable resources.

### CITATION LIST

### Patent Literature

Patent Literature 1: Published Japanese Translation of PCT International Publication for Patent Application, No. 2020-504552

### SUMMARY OF INVENTION

### Technical Problem

The resource allocation system disclosed in Patent Literature 1 maps a virtual network for all hardware configuring a physical infrastructure according to a specific management policy. Thus, in a case where a physical infrastructure is divided into a plurality of management domains, the resource allocation system may not be able to map the virtual network across domains.

In view of the above-described problems, an object of the present disclosure is to provide a management system, a management device, and a management method capable of mapping a virtual network across domains.

### Solution to Problem

According to a first aspect of the present disclosure, there is provided a management system including first management means for managing a plurality of first data centers included in a first area: second management means for managing a plurality of second data centers included in a second area in a range different from the first area; and third management means for selecting a data center candidate in which a first virtual node is to be deployed from among the plurality of first data centers and a data center candidate in which a second virtual node is to be deployed from among the plurality of second data centers based on communication performance information between a first data center and a second data center, in which the first management means specifies the first data center in which the first virtual node is to be deployed based on the candidate in which the first virtual node is to be deployed, and the second management means specifies the second data center in which the second virtual node is to be deployed based on the candidate in which the second virtual node is to be deployed.

According to a second aspect of the present disclosure, there is provided a management device including a selection unit configured to select at least one first data center that is a candidate in which a first virtual node is to be deployed from among a plurality of first data centers and at least one second data center that is a candidate in which a second virtual node is to be deployed from among a plurality of second data centers based on communication performance information between the plurality of first data centers included in a first area and the plurality of second data centers included in a second area in a range different from the first area; and a communication unit configured to transmit information regarding the at least one first data center that is the candidate in which the first virtual node is to be deployed to first management means for managing the plurality of first data centers, and transmit information regarding the at least one second data center that is the candidate in which the second virtual node is to be deployed to second management means for managing the plurality of second data centers.

According to a third aspect of the present disclosure, there is provided a management method including selecting at least one first data center that is a candidate in which a first virtual node is to be deployed from among a plurality of first data centers and at least one second data center that is a candidate in which a second virtual node is to be deployed from among a plurality of second data centers based on communication performance information between the plurality of first data centers included in a first area and the plurality of second data centers included in a second area in a range different from the first area: specifying the first data center in which the first virtual node is to be deployed from among the at least one first data center selected as the candidate based on the communication performance information; and specifying the second data center in which the second virtual node is to be deployed from among the at least one second data center selected as the candidate based on the communication performance information.

### Advantageous Effects of Invention

According to the present disclosure, it is possible to provide a management system, a management device, and a management method capable of mapping a virtual network across domains.

### BRIEF DESCRIPTION OF DRAWINGS

FIG. 1 is a configuration diagram of a management system according to a first example embodiment.

FIG. 2 is a configuration diagram of a management device according to the first example embodiment.

FIG. 3 is a configuration diagram of the management device according to the first example embodiment.

FIG. 4 is a diagram illustrating a flow of a process of specifying a data center in which a virtual node is deployed in the management system according to the first example embodiment.

FIG. 5 is a configuration diagram of a management system according to a second example embodiment.

FIG. 6 is a configuration diagram of a virtualization management system according to a second example embodiment.

FIG. 7 is a configuration diagram of an edge orchestrator according to the second example embodiment.

FIG. 8 is a configuration diagram of an E2E orchestrator according to the second example embodiment.

FIG. 9 is a diagram for describing collection of performance information according to the second example embodiment.

FIG. 10 is a diagram illustrating a flow of a performance information management process according to the second example embodiment.

FIG. 11 is a diagram illustrating a flow of an environmental conditions management process according to the second example embodiment.

FIG. 12 is a diagram illustrating a flow of a process of extracting a pair of data centers that are candidates in which a virtual node is to be deployed according to the second example embodiment.

FIG. 13 is a diagram illustrating a flow of a process of determining a data center in which a virtual node is deployed according to the second example embodiment.

FIG. 14 is a configuration diagram of an orchestrator according to each example embodiment.

### EXAMPLE EMBODIMENT

### First Example Embodiment

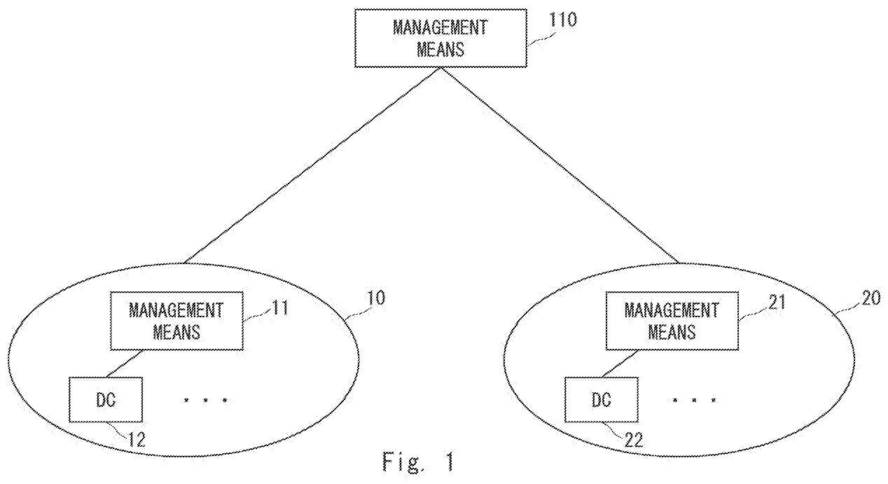

Hereinafter, example embodiments of the present invention will be described with reference to the drawings. A configuration example of a management system according to a first example embodiment will be described with reference to FIG. 1. The management system in FIG. 1 includes management means 11 for managing a plurality of data centers (DC) 12 included in an area 10. The management system in FIG. 1 further includes management means 21 for managing a plurality of data centers 22 included in an area 20. The management system in FIG. 1 further includes management means 110. The management means 110 communicates with the management means 11 and the management means 21. The area 20 manages the data center 22 included in an area in a range different from the area 10. For example, each of the area 10 and the area 20 may be an area on a city basis or an area on a prefecture basis, the area 10 may be an area on a city basis, and the area 20 may be an area on a prefecture basis including a plurality of cities. That is, the area 10 and the area 20 may not include an overlapping area, a part of the area 10 may overlap the area 20, or the entire area 10 may be included in the area 20. The area may be referred to as a domain or a cloud.

Although it is illustrated in FIG. 1 that the management means 11 exists in the area 10, the management means 11 may be disposed outside the area 10 and manage a plurality of data centers 12 existing in the area 10. Similarly, the management means 21 may be disposed outside the area 20 and manage a plurality of data centers 22 existing in the area 20.

The management means 11, the management means 21, and the management means 110 may be a computer device in which processing is executed by a processor executing a program stored in a memory. For example, the management means 11 may be a single computer device or a single server device. Alternatively, the management means 11 may be a computer device group in which a plurality of computer devices operate in cooperation or a server device group in which a plurality of server devices operate in cooperation. The management means 110 and the management means 21 may have configurations similar to those of the management means 11. Alternatively, the management means 11 may be a software resource included in a management system or a management server that manages the entire network, and may be a software resource allocated to manage the plurality of data centers 12 existing in the area 10. The management means 21 may be a software resource included in a management system or a management server that manages the entire network, and may be a software resource allocated to manage the plurality of data centers 22 existing in the area 20. The management means 110 may be a software resource included in a management system or a management server that manages the entire network.

The data center 12 and the data center 22 may be computer devices in which processing is executed by a processor executing a program stored in a memory. The data center 12 and the data center 22 can execute various functions by being equipped with software. Each of the data center 12 and the data center 22 may be a single computer device or a computer device group in which a plurality of computer devices operate in cooperation. Each of the data center 12 and the data center 22 may be a single server device or a server device group.

The management means 110 may manage performance information related to data centers. The performance information may be referred to as communication performance information. The performance information may be, for example, a transmission rate or a communication band of data transmitted between data centers in the same area, or a transmission rate or a communication band of data transmitted between the data center 12 and the data center 22. The performance information may be the time required for data to arrive from one data center 12 to the other data center 12 or the data center 22, data fluctuation, or the like. The time required for data to arrive from one data center 12 to the other data center 12 or the data center 22 may be referred to as a transmission time or a delay time. The performance information may be statistical information of a time required for a plurality of pieces of data to reach the other data center 12 or the data center 22 from one data center 12, for example, an average. The management means 110 may collect performance information from the management means 11 and the management means 21 and further analyze the performance information. For example, the management means 110 may transmit a message for instructing the management means 11 and the data center 12 to transmit measurement data and measure performance information. Although the example in which the data center 12 is a data transmission source has been described above, the same applies to a case where the data center 22 is a data transmission source.

The management means 110 selects at least one data center 12 that is a candidate in which a virtual node is to be deployed on the basis of performance information between data centers belonging to different areas, that is, between the data center 12 and the data center 22. The management means 110 selects at least one data center 22 that is a candidate in which a virtual node is to be deployed on the basis of the performance information regarding the data center 12 and the data center 22. The management means 110 notifies the management means 11 of information regarding the data center 12 selected as a candidate in which a virtual node is to be deployed, and notifies the data center 12 of information regarding the data center 22 selected as a candidate in which a virtual node is to be deployed.

The management means 110 may specify an area in which a virtual node is deployed, for example, the area 10 or the area 20, according to a function of the virtual node to be deployed. The management means 110 may specify an area in which a virtual node is to be deployed according to a function and a service requirement of the virtual node to be deployed. For example, a transmission time, a delay time, or the like may be defined as the service requirement.

For example, the management means 11 may manage environmental conditions of the plurality of data centers 12. The environmental conditions may be, for example, a failure frequency of each data center 12 or a power consumption amount of each data center 12. The management means 11 may collect at least one of the failure frequency or the power consumption amount from each data center 12 and further analyze the failure frequency and the power consumption.

The management means 11 may manage which virtual node is currently allocated to each data center 12 in order to specify the data center 12 to which a virtual node is to be allocated. Allocation may also be referred to as deployment. The management means 11 may manage a free space of a software resource in each data center 12. The virtual node may be, for example, a virtualized network function. The virtual node may include all functions of a certain physical node, or may include some of all the functions of a certain physical node.

Similarly to the management means 11, the management means 21 may also manage environmental conditions regarding the plurality of data centers 22 and information necessary for allocating virtual nodes to the data center 22.

The management means 11 specifies the data center 12 in which a virtual node is to be deployed from at least one data center 12 selected as a candidate on the basis of the performance information between each data center 12 and each data center 22. Specifying may also be referred to as determining.

The management means 21 also specifies the data center 22 in which a virtual node is to be deployed from at least one data center 22 selected as a candidate on the basis of the performance information between each data center 12 and each data center 22.

The candidates of the data center 12 and the candidates of the data center 22 selected on the basis of the performance information may be, for example, the data center 12 and the data center 22 in which the performance information satisfies a predetermined requirement. The data center 12 and the data center 22 in which the performance information satisfies a predetermined requirement may be, for example, the data center 12 and the data center 22 that realize a transmission time shorter than a predetermined time.

The performance information between each data center 12 and each data center 22 may be generated, for example, by the management means 11 giving an instruction for transmission of measurement data from each data center 12 to each data center 22. The management means 11 may generate the performance information from a transmission result or the like of measurement data obtained from each data center 12, and the management means 21 may generate the performance information from a reception result or the like of measurement data obtained from each data center 22. The management means 11 and the data center 12 transmit the generated performance information to the management means 110.

The performance information between each data center 12 and each data center 22 may be generated by the management means 110 instructing the data center 12 or the data center 22 to transmit measurement data via the management means 11 and the management means 21. Alternatively, the performance information between each data center 12 and each data center 22 may be generated by each data center periodically transmitting measurement data without receiving an instruction from the management means 110.

For example, the management means 110 may select at least one data center pair in which a transmission time of the measurement data is shorter than a predetermined time from among a plurality of pairs obtained by combining any of the plurality of data centers 12 and any of the plurality of data centers 22. In this case, the management means 11 may specify one data center from the data centers included in the selected pair, and deploy the virtual node to the specified data center 12. The management means 21 may specify the data center in which a virtual node is to be deployed from the sent pair of data centers 22.

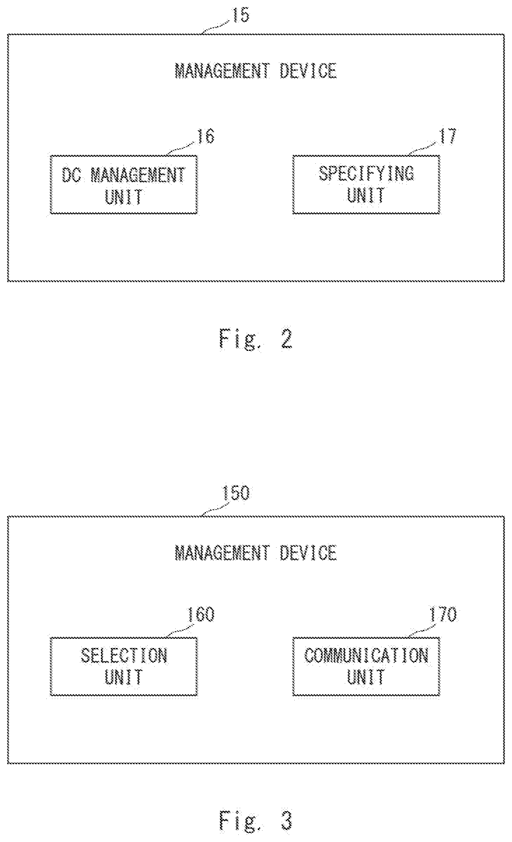

Here, a configuration example of the management means 11 will be described with reference to FIG. 2. Here, an example in which the management means 11 is configured by a management device 15 as one device will be described. The management device 15 includes a DC management unit 16 and a specifying unit 17. The DC management unit 16 manages a plurality of data centers 12. For example, the DC management unit 16 manages environmental conditions related to the plurality of data centers 12 and information necessary for allocating virtual nodes to the data center 12. The specifying unit 17 specifies the data center 12 in which a virtual node is to be deployed from at least one data center 12 selected as a candidate on the basis of the performance information between each data center 12 and each data center 22. Similarly to the management means 11, the management means 21 is configured by a device similar to the management device 15.

Next, a configuration example of the management means 110 will be described with reference to FIG. 3. Here, an example in which the management means 110 is configured by a management device 150 as one device will be described. The management device 150 includes a selection unit 160 and a communication unit 170. The selection unit 160 selects at least one data center that is a candidate in which a virtual node is to be deployed for each of the area 10 and the area 20 on the basis of performance information between data centers. The communication unit 170 transmits information regarding at least one data center 12 that is a candidate in which a virtual node is to be deployed to the management means 11, and transmits information regarding at least one data center 22 that is a candidate in which a virtual node is to be deployed to the management means 21.

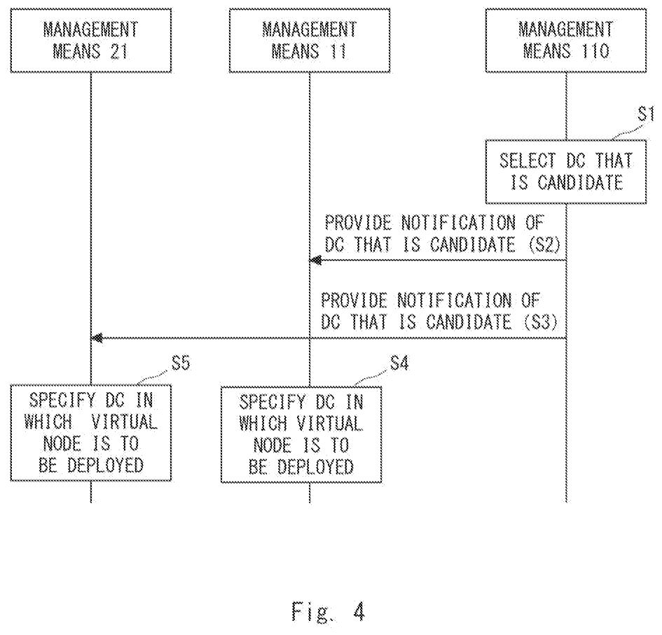

Next, a flow of a process of specifying a data center in which a virtual node is to be deployed in the management system will be described with reference to FIG. 4. First, the management means 110 selects a data center that is a candidate in which a virtual node is to be deployed on the basis of the performance information (S1). Specifically, the management means 110 selects at least one data center 12 that is a candidate in which a virtual node is to be deployed from among the plurality of data centers 12 included in the area 10. The management means 110 selects at least one data center 22 that is a candidate in which a virtual node is to be deployed from among the plurality of data centers 22 included in the area 20.

Next, the management means 110 notifies the management means 11 of the data center 12 that is a candidate in which a virtual node is to be deployed (S2).

Next, the management means 110 notifies the management means 21 of the data center 22 that is a candidate in which a virtual node is to be deployed (S3). The management means 110 may execute steps S2 and S3 at substantially the same timing, or may execute step S2 after step S3.

Next, the management means 11 specifies the data center 12 in which a virtual node is to be deployed from at least one data center 12 that is a candidate in which a virtual node is to be deployed (S4). Similarly to the management means 11, the management means 21 also specifies the data center 22 in which a virtual node is to be deployed from at least one data center 22 that is a candidate in which a virtual node is to be deployed (S5).

As described above, the management system in FIG. 1 includes the management means 11 that manages a plurality of data centers included in the area 10, and includes the management means 21 that manages a plurality of data centers included in the area 20. The management means 11 deploys a virtual node to the data center 12 in the area 10, and the management means 21 deploys a virtual node to the data center 22 in the area 20. As a result, for example, since the management means that manages each area can deploy virtual nodes to a plurality of data centers belonging to different areas, the virtual nodes can be deployed across the areas.

### Second Example Embodiment

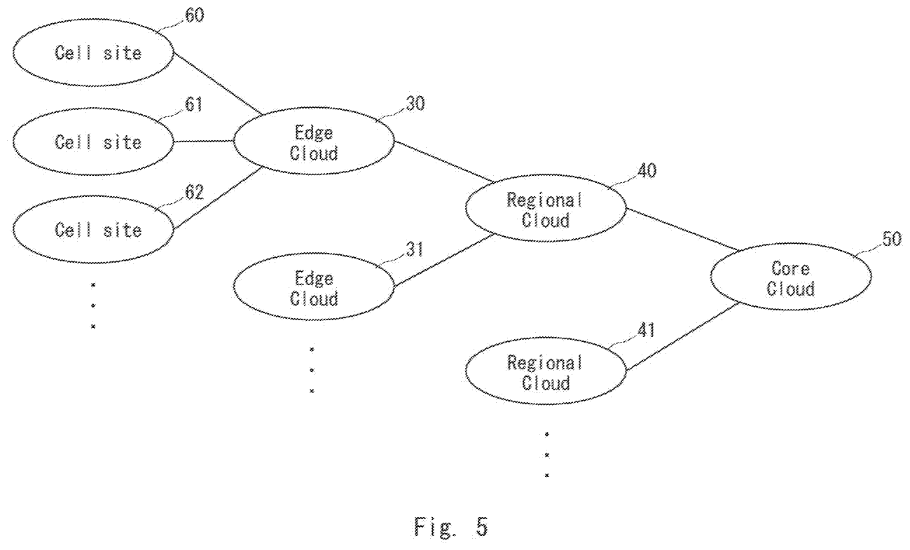

Next, a configuration example of a management system according to a second example embodiment will be described with reference to FIG. 5. A management system in FIG. 5 includes an edge cloud 30, an edge cloud 31, a regional cloud 40, a regional cloud 41, a core cloud 50, and cell sites 60 to 62. The edge cloud 30, the edge cloud 31, the regional cloud 40, the regional cloud 41, and the core cloud 50 correspond to the area 10 and the area 20 in FIG. 1. In FIG. 5, an example in which the area 10 and the area 20 in FIG. 1 have a hierarchical structure will be described. The cell sites 60 to 62 may be, for example, communication areas managed by a base station used for mobile communication. The base station may be referred to as, for example, an evolved Node B (eNB) or a gNB. The base station may be referred to as an NR or an NR entity. The numbers of edge clouds, regional clouds, core clouds, and cell sites are not limited to the numbers illustrated in FIG. 5.

The edge clouds 30 and 31 relay data transmitted between cell sites. For example, the edge cloud 30 transmits data received from the cell site 60 to the cell site 61 or the cell site 62. Alternatively, the edge cloud 30 transmits data received from the cell site 60 to the regional cloud 40 in order to relay the data to a cell site under the edge cloud 31. The edge cloud 30 and the edge cloud 31 may be provided, for example, for each specific region. The edge clouds 30 and 41 accommodate devices (for example, a RAN distributed unit (DU) or a RAN control/centralized unit (CU)) to which a large number of cell sites (for example, remote radio units (RUs) of base stations) are connected.

The regional clouds 40 and 41 relay data transmitted among the edge cloud 30, the edge cloud 31, and other edge clouds. The core cloud 50 relays data transmitted between the regional cloud 40, the regional cloud 41, and other regional clouds. The regional clouds 40 and 41 are the next connected sites of the edge clouds. Depending on a slice requirement, a CU corresponding to a DU deployed in the edge cloud is deployed in the regional cloud. The core cloud 50 is the next connected site of the regional cloud. The core cloud generally accommodates core network applications such as a 5th Generation Core (5GC) and an Evolved Packet Core (EPC). The arrangement of functions deployed in the edge cloud, the regional cloud, and the core cloud may be different depending on vendors.

The regional cloud 40 may be referred to as a higher cloud of the edge cloud 30 and the edge cloud 31, and the core cloud 50 may be referred to as a higher cloud of the regional cloud 40 and the regional cloud 41. The higher cloud may be referred to as a higher domain. The regional cloud 40 and the regional cloud 41 may be referred to as lower clouds of the core cloud 50, and the edge cloud 30 and the edge cloud 31 may be referred to as lower clouds of the regional cloud 40 and the regional cloud 41. The lower cloud may be referred to as a lower domain. In a case where data is transmitted to a data center of a cloud or a domain different from each cloud or each domain, the edge cloud 30, the edge cloud 31, the regional cloud 40, and the regional cloud 41 transmit data to a higher cloud or a higher domain. That is, the higher cloud relays communication between the lower clouds.

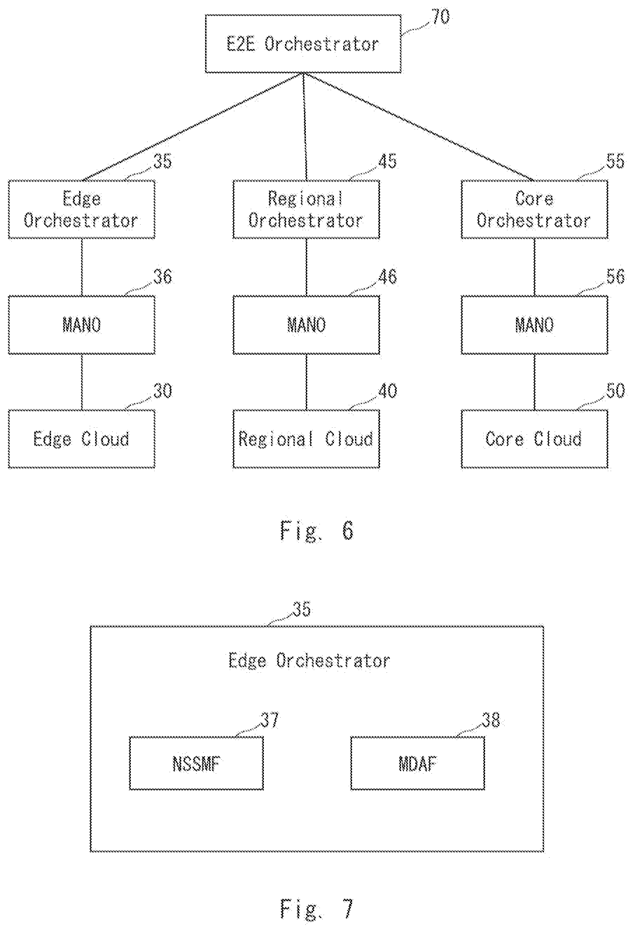

Next, a virtualization management system for constructing a virtualization system will be described with reference to FIG. 6. The virtualization management system in FIG. 6 includes an edge orchestrator 35, a management and orchestration (MANO) 36, a regional orchestrator 45, a MANO 46, a core orchestrator 55, a core orchestrator 55, and an E2E orchestrator 70. The E2E orchestrator 70 corresponds to the management means 110 in FIG. 1. The edge orchestrator 35, the regional orchestrator 45, and the core orchestrator 55 correspond to the management means 11 and the management means 21 in FIG. 1. The edge orchestrators 35, 45, and 55, the MANO 36, 46, and 56, and the E2E orchestrator 70 may be computer devices that operate when a processor executes a program stored in a memory. The edge orchestrators 35, 45, and 55, the MANO 36, 46, and 56, and the E2E orchestrator 70 may be a computer device group.

In order to optimize dynamic deployment of network functions, the MANO 36 constructs a virtualization system using, for example, a plurality of data centers included in the edge cloud 30. The edge orchestrator 35 manages the edge cloud 30 and analyzes the edge cloud 30. The regional orchestrator 45, the MANO 46, the core orchestrator 55, and the MANO 56 also execute functions and processes similar to those of the edge orchestrator 35 and the MANO 36. Although the edge cloud 31 and the regional cloud 41 are not illustrated in FIG. 6, it is assumed that an edge orchestrator and a MANO are also associated with the edge cloud 31, and a regional orchestrator and a MANO are also associated with the regional cloud 41.

Although the edge orchestrator 35 and the MANO 36 are illustrated as different devices or components in FIG. 6, for example, the edge orchestrator 35 may be a component configuring the MANO 36. For example, the MANO 36 may include an edge orchestrator 35, a virtual network function manager (VNFM), and a virtualised infrastructure manager (VIM). The VIM performs operation management of physical resources of a data center included in the edge cloud 30 and virtual resources on the data center. The VNFM performs management of a resource requirement required by a VNF and life cycle management of the VNF. The VNF is a virtualized network function group that operates on an NFVI. A network functions virtualization infrastructure (NFVI) is a basis for handling a physical resource such as a storage as a virtual resource. The NFVI is included in a data center. A system including the edge orchestrator 35 and the MANO 36 may be referred to as an NFV architecture.

The E2E orchestrator 70 collects and analyzes data necessary for deployment of a VNF across clouds or domains. The data required for deployment of a VNF may be, for example, performance information between data centers.

The virtualization management system in FIG. 6 deploys, for example, a radio access network (RAN) component across clouds. The RAN component includes a remote radio unit (RU), a RAN distributed unit (DU), and a RAN control/centralized unit (CU). The RU processes a radio frequency signal. The RU is mainly deployed in the cell sites 60 to 62. The RU may be configured by, for example, an antenna. For the DU and the CU, a cloud to be deployed is determined according to a service requirement or a slice requirement (hereinafter, referred to as a service requirement). Also for the VNF other than the DU and the CU, a cloud to be deployed is determined according to a slice requirement, a function of the VNF, and a requirement required for the VNF.

The DU and the CU are devices or functional blocks that perform baseband processing. The CU is a device connected to a core network device, and the DU is deployed between the RU and the CU. The CU mainly processes packet data and the like, and the DU processes data in a lower layer than the CU.

For example, the service requirements are defined as enhanced Mobile Broadband (eMBB), Ultra Reliable and Low Latency Communications (URLLC), and massive Machine Type Communication (mMTC). For example, in a case of executing a service that satisfies URLLC with the strictest delay condition, the CU and the DU may be deployed in the edge cloud 30 and the edge cloud 31. As a result, a transmission distance between the CU and the DU is shortened, and a delay time related to data transmission can be reduced. In a case of executing a service that satisfies eMBB that defines a high-speed and large-capacity communication service, the DU may be deployed in the edge cloud 30 and the edge cloud 31, and the CU may be deployed in the regional cloud 40 and the regional cloud 41. In a case of executing a service that satisfies mMTC that defines a communication service between a large number of terminals that are simultaneously connected, the DU may be deployed in the edge cloud 30 and the edge cloud 31, and the CU may be deployed in the core cloud 50. Specifically, the CU may be deployed at a location away from an edge cloud in order from a service with a strict delay requirement. Similarly to the CU, the DU may be flexibly deployed in the edge cloud 30, the regional cloud 40, and the core cloud 50 according to a service requirement.

In a case where the DU and the CU are deployed as virtual nodes or virtual machines in the edge cloud, the regional cloud, and the core cloud, the DU and the CU may be referred to as a vDU and a vCU.

Next, a configuration example of the edge orchestrator 35 will be described with reference to FIG. 7. Since the regional orchestrator 45 and the core orchestrator 55 have the same configuration as that of the edge orchestrator 35, a detailed configuration example of the regional orchestrator 45 and the core orchestrator 55 will not be described.

The edge orchestrator 35 includes a network slice subnet management function (NSSMF) 37 and a management data analytics function (MDAF) 38. The NSSMF 37 and the MDAF 38 may be referred to as, for example, an NSSMF entity 37 and an MDAF entity 38.

The NSSMF 37 collects and manages information such as failure information and power consumption as environmental conditions of a data center group included in a target cloud. The NSSMF 37 may also be referred to as a management unit. The target cloud is, for example, the edge cloud 30. The target cloud managed by the NSSMF 37 may be referred to as a network subnet slice. The network subnet slice is created by further dividing a network slice.

For example, the NSSMF 37 may collect and manage environmental conditions for each data center. The failure information is divided into, for example, failure information of software and failure information of hardware. For example, a failure alarm indicating a failure of software of a data center may be transmitted from the data center to the NSSMF via an element management system (EMS). The EMS manages, for example, the VNF. For example, the EMS may manage one data center, may manage data centers included in one cloud, or may manage each data center included in a plurality of clouds. A failure alarm indicating a failure and a power consumption amount of the hardware of the data center may be transmitted to the NSSMF via the VIM.

The MDAF 38 may analyze the environmental conditions collected by the NSSMF 37 to specify or select a data center with the best environmental conditions from among candidates of data centers in which the vCU or the vDU is to be deployed. The MDAF 38 may also be referred to as a specifying unit. The candidates of data centers may be sent from the E2E orchestrator 70 that will be described later. As the environmental conditions, for example, the number of failure alarms or the number of physical failures in which a severity indicating a level of a failure is equal to or higher than a minor level may be used. Alternatively, as the environmental conditions, a power consumption rate per day, a power failure occurrence rate per week, a power failure time, an average value of a heat generation amount of a server, a storage, or the like per day, a power consumption amount per rack per day, an average value of a heat generation amount, or the like in a data center may be used. As the environmental conditions, at least one of the pieces of information described above may be used. For example, in a case where at least one criterion among the number of failure alarms, the number of physical failures, and the information regarding power is used as the environmental conditions, the MDAF 38 may score the environmental conditions for each criterion and set a total score as a value of the environmental conditions. For example, as the number of failure alarms and the number of physical failures become smaller, the score may become higher. The score of the information regarding power may become higher as each value becomes smaller. The value of the environmental conditions obtained by summing the scores indicates that the higher the score, the better the quality, and the MDAF 38 may specify a data center with a higher score.

The physical failures may include, for example, power interruption of a server due to power shortage and a network failure due to an optical fiber cable failure. The power consumption rate may be a value obtained by multiplying a value obtained by dividing a total amount of power supply by a power consumption amount by 100.

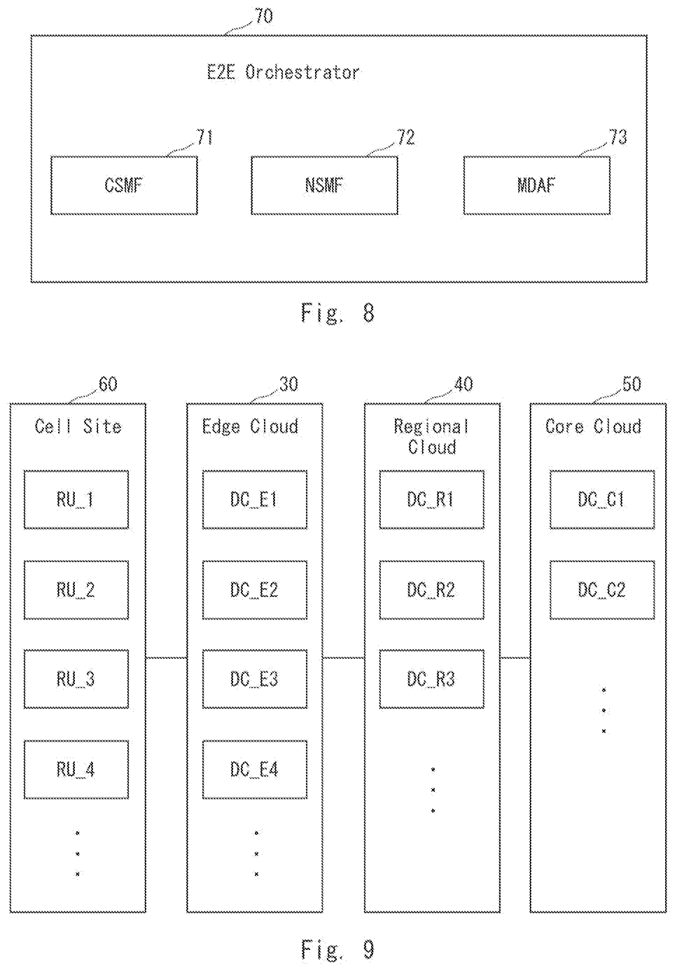

Next, a configuration example of the E2E orchestrator 70 will be described with reference to FIG. 8. The E2E orchestrator 70 includes a communication service management function (CSMF) 71, a network slice management function (NSMF) 72, and an MDAF 73. The CSMF 71 and the NSMF 72 may be referred to as a CSMF entity 71 and an NSMF entity 72.

The CSMF 71 manages communication services. For example, the CSMF 71 may manage data transmitted as a user plane. The CSMF 71 receives a deployment request for a vCU and a vDU from an operator operating the E2E orchestrator 70. Specifically, the CSMF 71 receives a deployment request from the operator via an input interface such as a touch panel, a keyboard, or a microphone. The deployment request may include information regarding a service requirement. The information regarding the service requirement indicates eMBB, URLLC, or mMTC, and may further include a transmission time of data between a vCU and a vDU.

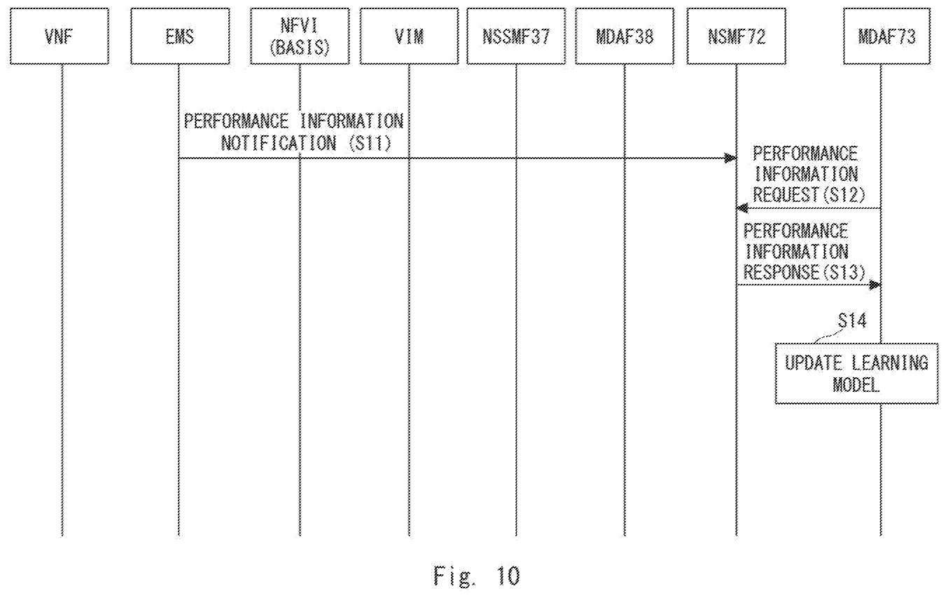

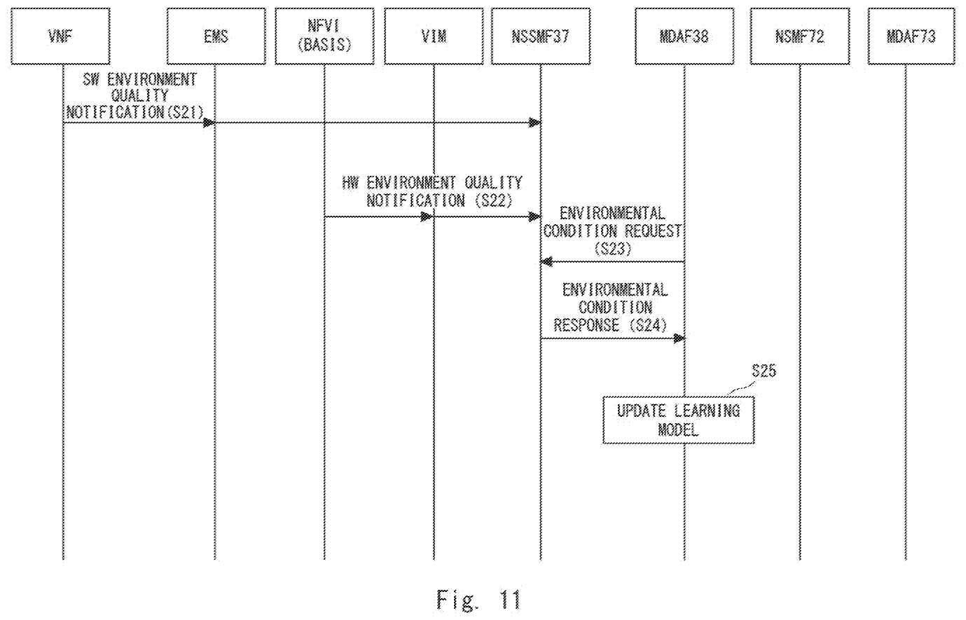

The NSMF 72 collects and manages performance information between data centers across a plurality of clouds. Here, the performance information collected by the NSMF 72 will be described with reference to FIG. 9. FIG. 9 illustrates that the cell site 60 includes a plurality of RUs including an RU_1 to an RU_4. The numbers 1 to 4 are identification information for identifying RUs. It is illustrated that the edge cloud 30 includes a plurality of data centers (DCs) including a DC_E1 to a DC_E4, the regional cloud 40 includes a plurality of DCs including a DC_R1 to a DC_R3, and the core cloud 50 includes a plurality of DCs including a DC_C1 and a DC_C2. E1 to E4, R1 to R3, and C1 to C2 are identification information for identifying DCs.

For example, the NSMF 72 collects information regarding a transmission time of data on a transmission path between the DC_E1 and each DC included in the regional cloud 40. The NSMF 72 may collect transmission times of all combinations of data of each DC included in the edge cloud 30 and each DC included in the regional cloud 40. Alternatively, the NSMF 72 may collect data transmission times in some of all combinations of each DC included in the edge cloud 30 and each DC included in the regional cloud 40.

Similarly between the regional cloud 40 and the core cloud 50, the NSMF 72 may collect a transmission time of data between the DC included in the regional cloud 40 and the DC included in the core cloud 50. The NSMF 72 may collect a transmission time of data between each RU included in the cell site 60 and each DC included in the edge cloud 30.

For example, the NSMF 72 may determine a DC that will transmit measurement data and a DC to which the measurement data is to be transmitted, and instruct the DC that will transmit the measurement data to transmit the measurement data. The NSMF 72 may collect information regarding a transmission time of the measurement data from the DC that has received the measurement data. For example, the DC that transmits the measurement data may set a transmission time in the measurement data, and the DC that receives the measurement data may specify the time at which the measurement data is received. The DC that receives the measurement data may specify a transmission time of the measurement data by subtracting the time set in the measurement data from the time at which the measurement data is received.

The MDAF 73 analyzes performance information collected in the NSMF 72, for example, information regarding a transmission time, to determine a data center satisfying a service requirement. For example, it is assumed that a DU is deployed in the edge cloud 30 and a CU is deployed in the regional cloud 40 in a case where a service satisfying eMBB that defines a high-speed and large-capacity communication service is executed. It is assumed that, as a service requirement for eMBB, a transmission time related to data transmission between a vCU and a vDU is set to, for example, 1 millisecond (msecc). In this case, the MDAF 73 extracts a pair of data centers in which a transmission time of the measurement data between the data center included in the edge cloud 30 and the data center included in the regional cloud 40 is 1 msec or less. The MDAF 73 may extract a plurality of pairs. That is, the MDAF 73 extracts candidates of data centers in which a vCU and a vDU are deployed.

The MDAF 73 transmits identification information of the data centers that are candidates to the edge orchestrator 35 and the regional orchestrator 45 of the edge cloud and the regional cloud having the data centers included in the extracted pair.

Next, a flow of a performance information management process will be described with reference to FIG. 10. First, performance information regarding a data center managed by the EMS is transmitted from the EMS to the NSMF 72 (S11). The EMS transmits performance information between the data centers to the NSMF 72. The performance information between the data centers may be, for example, a transmission time of measurement data transmitted between the data centers. It is assumed that the performance information also includes information for identifying a data center that is a transmission source of the measurement data and a data center that is a transmission destination of the measurement data.

For example, the EMS may receive measurement data, acquire performance information from a data center in which a transmission time has been specified, and transmit the acquired performance information to the NSMF 72. FIG. 10 illustrates that one EMS notifies the NSMF 72 of the performance information, but a plurality of EMSs transmit the performance information to the NSMF 72.

The EMS may transmit the performance information to the NSMF 72 as a response to a request message received from the NSMF 72. In a case where the EMS receives a request message for requesting performance information between specific data centers from the NSMF 72, the EMS having the performance information between the specified specific data centers may respond to the NSMF 72 with the performance information.

Next, the MDAF 73 transmits a performance information request message to the NSMF 72 to acquire the performance information from the NSMF 72 (S12). Next, the NSMF 72 transmits a performance information response message including the performance information to the MDAF 73 in order to transmit the performance information to the MDAF 73 (S13). The MDAF 73 may periodically send a performance information request message, and obtain the performance information from the NSMF 72. Alternatively, the MDAF 73 may transmit the performance information request message at any timing, and acquire the performance information from the NSMF 72.

Next, the MDAF 73 updates the managed learning model using the acquired performance information (S14). The learning model is used to output a candidate of a data center in which a virtual node is to be deployed. For example, in a case where the type of cloud in which a virtual node is to be deployed is input, a learning model may output at least one candidate of a pair of data centers in which the virtual node is to be deployed. The type of cloud may be, for example, information for identifying an edge cloud, a regional cloud, or a core cloud. The learning model outputs candidates of a pair of data centers by using the performance information. For example, the learning model extracts candidates of a pair of data centers satisfying a transmission time requirement included in service requirements.

Next, a flow of an environmental condition management process will be described with reference to FIG. 11. First, the VNF transmits a software environmental condition notification message to the NSSMF 37 via the EMS in order to notify the NSSMF 37 of environmental conditions related to software (SW) (S21). The environmental conditions related to the software include, for example, failure information of the software. The VNF is, for example, a function of a virtual node deployed in a data center in the edge cloud 30. The VNF notifies the NSSMF 37 included in the edge orchestrator 35 that manages the edge cloud 30 of the environmental conditions related to the software.

Next, the NFVI transmits a hardware environmental condition notification to the NSSMF 37 via the VIM in order to notify the NSSMF 37 of environmental conditions related to hardware (HW) (S22). The environmental conditions related to the hardware include failure information of the hardware and information regarding power. The NFVI is deployed in a data center in the edge cloud 30 and is a basis for handling a physical resource such as a storage as a virtual resource. The NFVI notifies the NSSMF 37 included in the edge orchestrator 35 that manages the edge cloud 30 of environmental conditions related to the hardware.

In a case where a failure or the like is detected, the VNF and the NFVI transmit the environmental conditions to the NSSMF 37. Therefore, the order of steps S21 and S22 may be reversed from the order illustrated in FIG. 11.

Next, the MDAF 38 transmits an environmental condition request message to the NSSMF 37 in order to acquire the environmental conditions from the NSSMF 37 (S23). Next, the NSSMF 37 transmits an environmental condition response message including the environmental conditions to the MDAF 38 in order to transmit the performance information to the MDAF 38 (S24). The MDAF 38 may periodically transmit the environmental condition request message, and acquire the environmental conditions from the NSSMF 37. Alternatively, the NSSMF 37 may transmit the environmental condition request message at ay timing, and acquire the environmental conditions from the NSSMF 37.

Next, the MDAF 38 updates the managed learning model by using the acquired environmental conditions (S25). The learning model is used to output a data center in which a virtual node is to be deployed from among the data centers that are candidates. For example, the learning model may output a data center in which a virtual node is to be deployed in a case where a candidate of the data center in which the virtual node is to be deployed is input. The learning model specifies a data center by using the environmental conditions. For example, the learning model specifies an optimal data center according to criteria related to the environmental conditions. The optimal data center may be, for example, the most available or reliable data center.

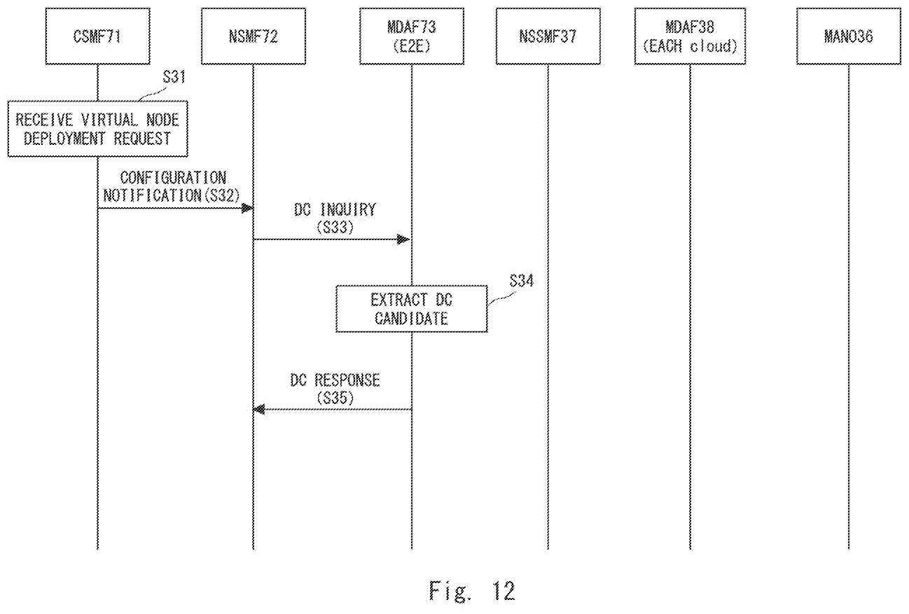

Next, a flow of a process of extracting a pair of data centers that are candidates in which virtual nodes are to be deployed will be described with reference to FIG. 12. First, the CSMF 71 receives a virtual node deployment request from an operator operating the E2E orchestrator 70 (S31). For example, the deployment request may include information regarding an area in which a service is provided and a service requirement. For example, it is assumed that eMBB is designated as the service requirement, and that a transmission time between the vCU and the vDU is 1 msec or less.

Next, the CSMF 71 transmits, to the NSMF 72, a configuration notification message including an area in which a service is provided and configuration information indicating a configuration of deployment of the vCU and the vDU satisfying the designated service requirement (S32). For example, it is assumed that each of eMBB, URLCC, and mMTC and the cloud type in which the vCU and the vDU are deployed are determined in advance. For example, if eMBB is specified, it may be provided that the vDU is deployed in the edge cloud, and the vCU is deployed in the regional cloud. Here, because eMBB is designated as a service requirement, the CSMF 71 sends, to the NSMF 72, a configuration notification message indicating that the vDU is deployed to the edge cloud and the vCU is deployed to the regional cloud.

Next, the NSMF 72 transmits a DC inquiry notification message including the area in which a service is provided and the configuration of deployment of a virtual node to the MDAF 73 (S33). The MDAF 73 extracts a pair of data centers in which virtual nodes, that is, the vCU and the vDU are deployed (S34). For example, the MDAF 73 may determine an edge cloud closest to the area in which the service is provided. In this case, the MDAF 73 extracts a pair of data centers that are candidates by using a transmission time between a data center included in the determined edge cloud and a data center included in each of the plurality of regional clouds. The MDAF 73 extracts a pair of data centers that are candidates by using the learning model described in FIG. 10.

Next, the MDAF 73 transmits a DC response message including information regarding the pair of data centers that are candidates to the NSMF 72 (S35).

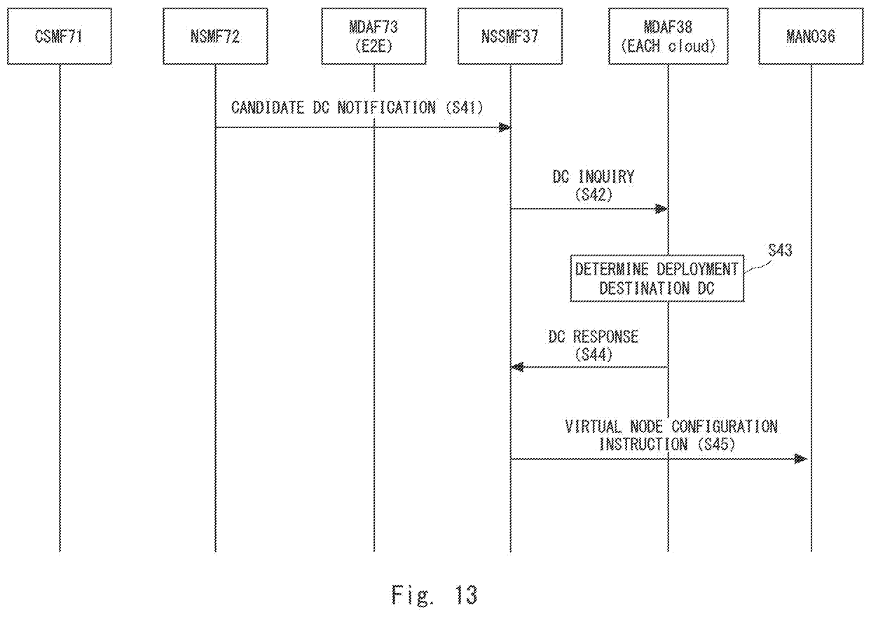

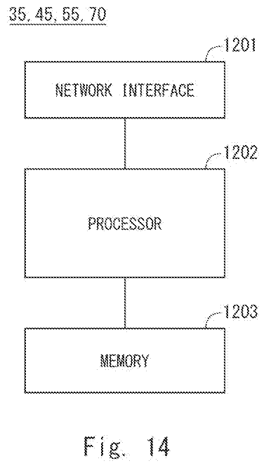

Next, a flow of a process of determining a data center in which a virtual node is to be deployed will be described with reference to FIG. 13. Here, it is assumed that the NSMF 72 is notified of information regarding a pair of data centers that are candidates in which a virtual node is to be deployed as described in FIG. 12.

First, the NSMF 72 transmits a candidate DC notification message including information regarding a data center that is a candidate in which a virtual node is to be deployed to the NSSMF 37 (S41). Specifically, the NSMF 72 notifies the NSSMF 37 of information regarding at least one data center included in the edge cloud 30 among data centers included in a pair of data centers that are candidates in which a virtual node is to be deployed. FIG. 13 illustrates that the NSMF 72 transmits the candidate DC notification message to the NSSMF 37. However, in practice, the NSMF 72 also notifies the NSSMF included in the regional orchestrator of the regional cloud of information regarding at least one data center included in the regional cloud.

Next, the NSSMF 37 transmits a DC inquiry message including the information regarding the data center that is a candidate in which a virtual node is to be deployed to the MDAF 38 in order to acquire the information regarding the data center in which a virtual node is to be deployed (S42).

Next, the MDAF 38 determines a data center in which a virtual node is to be deployed from among the data centers that are candidates (S43). Specifically, the MDAF 38 determines a data center from among the data centers that are candidates by using environmental conditions related to each data center. The MDAF 38 determines a data center in which a virtual node is to be deployed by using the learning model described in FIG. 11.

Next, the MDAF 38 transmits a DC response message including information regarding the determined data center to the NSSMF 37 (S44). Next, in order to cause the determined data center to configure a virtual node, the NSSMF 37 transmits a virtual node configuration instruction message including information regarding the determined data center to the MANO 36 (S45). The MANO 36 configures a VNF that is a vDU in the data center included in the virtual node configuration instruction message. The MANO associated with the regional orchestrator also configures a VNF that is a vCU in the data center determined in the regional orchestrator.

As described above, the E2E orchestrator 70 extracts candidates of data centers in which a virtual node is to be deployed across the clouds on the basis of a data transmission time between the clouds. The edge cloud 30, the regional cloud 40, and the core cloud 50 determine a data center in which a virtual node is to be deployed from the candidates of data centers sent from the E2E orchestrator 70 on the basis of the environmental conditions. As a result, it is possible to realize deployment of virtual nodes across the clouds. By determining a data center according to the performance information and the environmental conditions, a data center satisfying a service requirement can be determined. Each of the edge orchestrator 35, the regional orchestrator 45, and the core orchestrator 55 specifies or determines a data center in which a virtual node is to be deployed, and thus it is possible to distribute processing loads. That is, a processing load of each of the edge orchestrator 35, the regional orchestrator 45, and the core orchestrator 55 can be reduced compared with a case where one orchestrator specifies all data centers in which virtual nodes are to be deployed.

### Modified Example of Second Example Embodiment

A modified example of the process of specifying a data center in which a virtual node is to be deployed will be described. In the second example embodiment, an example in which each of the edge orchestrator and the regional orchestrator specifies a data center in which a virtual node is to be deployed according to environmental conditions has been described. In the following modified example, a description will be made of a case where the E2E orchestrator 70 specifies a data center in which a virtual node is to be deployed, and the edge orchestrator and the regional orchestrator 45 deploy the virtual node in the data center specified by the E2E orchestrator 70.

The MDAF 38 included in the edge orchestrator 35 may set ranks for the plurality of candidates of data centers sent from the NSMF 72 on the basis of the environmental conditions. The edge orchestrator 35 transmits information indicating ranks set for the plurality of respective candidates of data centers to the NSMF 72. Similarly, the MDAF included in the regional orchestrator 45 may set ranks for the plurality of candidates of data centers sent from the NSMF 72 on the basis of the environmental conditions. The regional orchestrator 45 transmits information indicating the ranks set for the plurality of respective candidates of data centers to the NSMF 72.

The NSMF 72 transmits, to the MDAF 73, the information indicating ranks set for the plurality respective candidates of data center received from the edge orchestrator 35 and the regional orchestrator 45.

The MDAF 73 specifies one of a plurality of pairs of data centers included in the edge cloud 30 and data centers included in the regional cloud 40, extracted in step S34 in FIG. 12. For example, the MDAF 73 may specify a pair of data centers that can be expected to have high availability in consideration of the environmental conditions although a transmission time is longer than that in other pairs. Alternatively, the MDAF 73 may specify a pair of data centers having a shorter transmission time although the availability considering the environmental conditions is shorter than that of other pairs.

The MDAF 73 may output the specified pair of data centers to the NSMF 72, and the NSMF 72 may transmit identification information of the specified data centers to the NSSMF 37 included in the edge orchestrator 35 and the NSSMF included in the regional orchestrator 45.

As described above, the E2E orchestrator 70 can determine a data center in which the vDU is to be deployed in the edge cloud 30 and a data center in which the vCU is to be deployed in the regional cloud 40 in units of pairs of data centers extracted according to the performance information.

For example, in a case where the orchestrator of each cloud specifies data centers in which virtual nodes are to be deployed on the basis of environmental conditions, the specified data centers may be different from a pair of data centers extracted in the MDAF 73. In this case, performance information between the specified data centers may not specify service requirements.

In the present modified example, since the MDAF 73 considers a rank set on the basis of the environmental conditions and further specifies data centers in units of pairs extracted on the basis of the performance information, it is possible to reduce the possibility of specifying a data center not satisfying the service requirements.

FIG. 14 is a block diagram illustrating a configuration example of the edge orchestrator 35, the regional orchestrator 45, the core orchestrator 55, and the E2E orchestrator 70 (hereinafter, referred to as the edge orchestrator 35 and the like). Referring to FIG. 14, the edge orchestrator 35 and the like include a network interface 1201, a processor 1202, and a memory 1203. The network interface 1201 may be used to communicate with other network nodes. The network interface 1201 may include, for example, a network interface card (NIC) conforming to IEEE 802.3 series.

The processor 1202 reads and executes software (computer program) from the memory 1203, thereby performing processing of the edge orchestrator 35 and the like described with reference to the flowcharts in the above example embodiment. The processor 1202 may be, for example, a microprocessor, a micro processing unit (MPU), or a central processing unit (CPU). The processor 1202 may include a plurality of processors.

The memory 1203 is configured with a combination of a volatile memory and a nonvolatile memory. The memory 1203 may include a storage disposed away from the processor 1202. In this case, the processor 1202 may access the memory 1203 through an input/output (I/O) interface (not shown).

In the example in FIG. 14, the memory 1203 is used to store a software module group. The processor 1202 can perform processing of the edge orchestrator 35 and the like described in the above example embodiment by reading and executing these software module groups from the memory 1203.

As described with reference to FIG. 14, each of the processors included in the edge orchestrator 35 and the like in the above-described example embodiments executes one or a plurality of programs including a command group for causing a computer to perform an algorithm described with reference to the drawings.

In the above-described example, the program includes a group of instructions (or software code) for causing a computer to perform one or more functions described in the example embodiments when being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD), or other memory technology, a CD-ROM, a digital versatile disc (DVD), a Blu-ray (registered trademark) disk, or other optical disk storage, and a magnetic cassette, a magnetic tape, a magnetic disk storage, or other magnetic storage devices. The program may be transmitted on a transitory computer-readable medium or a communication medium. As an example and not by way of limitation, the transitory computer-readable medium or the communication medium includes electrical, optical, acoustic, signals, or propagated signals in other forms.

Note that the present disclosure is not limited to the above-described example embodiments, and can be appropriately modified without departing from the gist.

Some or all of the above-described example embodiments can be described as in the following Supplementary Notes, but are not limited to the following Supplementary Notes.

### (Supplementary Note 1)

A management system including:
first management means for managing a plurality of first data centers included in a first area;
second management means for managing a plurality of second data centers included in a second area in a range different from the first area; and
third management means for selecting a data center candidate in which a first virtual node is to be deployed from among the plurality of first data centers and a data center candidate in which a second virtual node is to be deployed from among the plurality of second data centers based on communication performance information between a first data center and a second data center, in which
the first management means specifies the first data center in which the first virtual node is to be deployed based on the candidate in which the first virtual node is to be deployed, and
the second management means specifies the second data center in which the second virtual node is to be deployed based on the candidate in which the second virtual node is to be deployed.

### (Supplementary Note 2)

The management system according to Supplementary Note 1, in which the communication performance information is a transmission time of data transmitted between each of the first data centers and each of the second data centers.

### (Supplementary Note 3)

The management system according to Supplementary Note 1 or 2, in which
the first management means specifies the first data center in which the first virtual node is to be deployed based on environmental conditions in the plurality of first data centers, and
the second management means specifies the second data center in which the second virtual node is to be deployed based on environmental conditions in the plurality of second data centers.

### (Supplementary Note 4)

The management system according to Supplementary Note 3, in which the environmental conditions indicate a failure frequency or a power consumption amount in each of the first data centers or each of the second data centers.

### (Supplementary Note 5)

The management system according to any one of Supplementary Notes 1 to 4, in which the third management means specifies an area in which the first virtual node and the second virtual node are to be deployed according to functions of the first virtual node and the second virtual node.

### (Supplementary Note 6)

The management system according to any one of Supplementary Notes 1 to 5, in which
the first virtual node is a distributed unit (DU) that performs baseband processing, and
the second virtual node is a central unit (CU) that processes data in a higher layer than a layer handled by the DU.

### (Supplementary Note 7)

A management device including:
a selection unit configured to select at least one first data center that is a candidate in which a first virtual node is to be deployed from among a plurality of first data centers and at least one second data center that is a candidate in which a second virtual node is to be deployed from among a plurality of second data centers based on communication performance information between the plurality of first data centers included in a first area and the plurality of second data centers included in a second area in a range different from the first area; and
a communication unit configured to transmit information regarding the at least one first data center that is the candidate in which the first virtual node is to be deployed to first management means for managing the plurality of first data centers, and transmit information regarding the at least one second data center that is the candidate in which the second virtual node is to be deployed to second management means for managing the plurality of second data centers.

### (Supplementary Note 8)

The management device according to Supplementary Note 7, in which the communication performance information is a transmission time of data transmitted between each of the first data centers and each of the second data centers.

### (Supplementary Note 9)

The management device according to Supplementary Note 7 or 8, in which the selection unit specifies an area in which the first virtual node and the second virtual node are to be deployed according to functions of the first virtual node and the second virtual node.

### (Supplementary Note 10)

The management device according to any one of Supplementary Notes 7 to 9, in which
the first virtual node is a distributed unit (DU) that performs baseband processing, and
the second virtual node is a central unit (CU) that processes data in a higher layer than a layer handled by the DU.

### (Supplementary Note 11)

A management method including:
selecting at least one first data center that is a candidate in which a first virtual node is to be deployed from among a plurality of first data centers and at least one second data center that is a candidate in which a second virtual node is to be deployed from among a plurality of second data centers based on communication performance information between the plurality of first data centers included in a first area and the plurality of second data centers included in a second area in a range different from the first area;
specifying the first data center in which the first virtual node is to be deployed from among the at least one first data center selected as the candidate based on the communication performance information; and
specifying the second data center in which the second virtual node is to be deployed from among the at least one second data center selected as the candidate based on the communication performance information.

### (Supplementary Note 12)

The management method according to Supplementary Note 11, in which the communication performance information is a transmission time of data transmitted between each of the first data centers and each of the second data centers.

### (Supplementary Note 13)

The management method according to Supplementary Note 11 or 12, in which
in a case where the first data center is specified, the first data center in which the first virtual node is to be deployed is specified based on environmental conditions in the plurality of first data centers, and
in a case where the second data center is specified, the second data center in which the second virtual node is to be deployed is specified based on environmental conditions in the plurality of second data centers.

### (Supplementary Note 14)

The management method according to Supplementary Note 13, in which the environmental conditions indicate a failure frequency or a power consumption amount in each of the first data centers or each of the second data centers.

### (Supplementary Note 15)

The management method according to any one of Supplementary Notes 11 to 14, in which, in a case where the first data center and the second data center are selected, an area in which the first virtual node and the second virtual node are to be deployed is specified according to functions of the first virtual node and the second virtual node.

### (Supplementary Note 16)

The management method according to any one of Supplementary Notes 11 to 15, in which
the first virtual node is a distributed unit (DU) that performs baseband processing, and
the second virtual node is a central unit (CU) that processes data in a higher layer than a layer handled by the DU.

### (Supplementary Note 17)

A management method including:
selecting at least one first data center that is a candidate in which a first virtual node is to be deployed from among a plurality of first data centers and at least one second data center that is a candidate in which a second virtual node is to be deployed from among a plurality of second data centers based on communication performance information between the plurality of first data centers included in a first area and the plurality of second data centers included in a second area in a range different from the first area; and
transmitting information regarding the at least one first data center that is the candidate in which the first virtual node is to be deployed to first management means for managing the plurality of first data centers, and transmitting information regarding the at least one second data center that is the candidate in which the second virtual node is to be deployed to second management means for managing the plurality of second data centers.

### (Supplementary Note 18)

The management method according to Supplementary Note 17, in which the communication performance information is a transmission time of data transmitted between each of the first data centers and each of the second data centers.

### (Supplementary Note 19)

The management method according to Supplementary Note 17 or 18, in which, in a case where the first data center and the second data center are selected, an area in which a virtual node is to be deployed is specified according to a function of the virtual node.

### (Supplementary Note 20)

The management method according to any one of Supplementary Notes 17 to 19, in which
the first virtual node is a distributed unit (DU) that performs baseband processing, and
the second virtual node is a central unit (CU) that processes data in a higher layer than a layer handled by the DU.

Note that the present invention is not limited to the example embodiments explained above and can be changed as appropriate without departing from the scope of the present invention.

### REFERENCE SIGNS LIST

10 AREA
11 MANAGEMENT MEANS
12 DATA CENTER
15 MANAGEMENT DEVICE
16 DC MANAGEMENT UNIT
17 SPECIFYING UNIT
20 AREA
21 MANAGEMENT MEANS
22 DATA CENTER
30 Edge Cloud
31 Edge Cloud
35 Edge Orchestrator
36 MANO
37 NSSMF
38 MDAF
40 Regional Cloud
41 Regional Cloud
45 Regional Orchestrator
46 MANO
50 Core Cloud
55 Core Orchestrator
56 MANO
60 Cell site
61 Cell site
62 Cell site
70 E2E Orchestrator
71 CSMF
72 NSMF
73 MDAF
110 MANAGEMENT MEANS
150 MANAGEMENT DEVICE
160 SELECTION UNIT
170 COMMUNICATION UNIT

What is claimed is:

1. A management system comprising:
at least one memory storing instructions, and
at least one processor configured to execute the instructions to;
manage a plurality of first data centers included in a first area;
manage a plurality of second data centers included in a second area in a range different from the first area; and
select a data center candidate in which a first virtual node is to be deployed from among the plurality of first data centers and a data center candidate in which a second virtual node is to be deployed from among the plurality of second data centers based on communication performance information between a first data center and a second data center,
specify the first data center in which the first virtual node is to be deployed based on the candidate in which the first virtual node is to be deployed, and
specify the second data center in which the second virtual node is to be deployed based on the candidate in which the second virtual node is to be deployed.

2. The management system according to claim 1, wherein the communication performance information is a transmission time of data transmitted between each of the first data centers and each of the second data centers.

3. The management system according to claim 1, wherein the at least one processor is further configured to execute the instructions to
specify the first data center in which the first virtual node is to be deployed based on environmental conditions in the plurality of first data centers, and
specify the second data center in which the second virtual node is to be deployed based on environmental conditions in the plurality of second data centers.

4. The management system according to claim 3, wherein the environmental conditions indicate a failure frequency or a power consumption amount in each of the first data centers or each of the second data centers.

5. The management system according to claim 1, wherein the at least one processor is further configured to execute the instructions to specify an area in which the first virtual node and the second virtual node are to be deployed according to functions of the first virtual node and the second virtual node.

6. The management system according to claim 1, wherein
the first virtual node is a distributed unit (DU) that performs baseband processing, and
the second virtual node is a central unit (CU) that processes data in a higher layer than a layer handled by the DU.

7. A management device comprising:
at least one memory storing instructions, and
at least one processor configured to execute the instructions to;
select at least one first data center that is a candidate in which a first virtual node is to be deployed from among a plurality of first data centers and at least one second data center that is a candidate in which a second virtual node is to be deployed from among a plurality of second data centers based on communication performance information between the plurality of first data centers included in a first area and the plurality of second data centers included in a second area in a range different from the first area; and
transmit information regarding the at least one first data center that is the candidate in which the first virtual node is to be deployed to a first management device configured to manage the plurality of first data centers, and transmit information regarding the at least one second data center that is the candidate in which the second virtual node is to be deployed to a second management device configured to manage the plurality of second data centers.

8. The management device according to claim 7, wherein the communication performance information is a transmission time of data transmitted between each of the first data centers and each of the second data centers.

9. The management device according to claim 7, wherein the at least one processor is further configured to execute the instructions to specify an area in which the first virtual node and the second virtual node are to be deployed according to functions of the first virtual node and the second virtual node.

10. The management device according to claim 7, wherein
the first virtual node is a distributed unit (DU) that performs baseband processing, and
the second virtual node is a central unit (CU) that processes data in a higher layer than a layer handled by the DU.

11.-16. (canceled)

17. A management method comprising:
selecting at least one first data center that is a candidate in which a first virtual node is to be deployed from among a plurality of first data centers and at least one second data center that is a candidate in which a second virtual node is to be deployed from among a plurality of second data centers based on communication performance information between the plurality of first data centers included in a first area and the plurality of second data centers included in a second area in a range different from the first area; and
transmitting information regarding the at least one first data center that is the candidate in which the first virtual node is to be deployed to a first management device configured to manage the plurality of first data centers, and transmitting information regarding the at least one second data center that is the candidate in which the second virtual node is to be deployed to a second management device configured to manage the plurality of second data centers.

18. The management method according to claim 17, wherein the communication performance information is a transmission time of data transmitted between each of the first data centers and each of the second data centers.

19. The management method according to claim 17, wherein, in a case where the first data center and the second data center are selected, an area in which a virtual node is to be deployed is specified according to a function of the virtual node.

20. The management method according to claim 17, wherein
the first virtual node is a distributed unit (DU) that performs baseband processing, and
the second virtual node is a central unit (CU) that processes data in a higher layer than a layer handled by the DU.
